(19) United States
(12) Patent Application Publication
(10) Pub. No.: US 2026/0354292 A1
(43) Pub. Date: Nov. 12, 2026

(54) GARDEN TOOL

(71) Applicant: Paul Zavacky, Saint Clairsville, OH (US)

(72) Inventor: Paul Zavacky, Saint Clairsville, OH (US)

(21) Appl. No.: 19/202,141

(22) Filed: May 8, 2025

(51) Int. Cl. A01B 1/12; A01B 1/16

(52) U.S. Cl. CPC A01B 1/12; A01B 1/16

(57) ABSTRACT

A garden tool includes a handle, a connector, and a tool head. The handle includes a first handle end and a second handle end. The connector is coupled to the second handle end. The tool head is coupled to the connector. The tool head is positioned essentially perpendicular to the handle. The tool head includes a panel, a rear edge, a pair of side edges, and a toothed edge. The rear edge is adjacent the connector. The side edges extend from and transverse to the rear edge. The toothed edge extends between the side edges. The toothed edge includes a plurality of teeth projecting from the panel. Each of the teeth includes a tip. The tips of the teeth are positioned such that the tip of a middle tooth of the teeth is furthest from the panel.

### (b) CROSS-REFERENCE TO RELATED APPLICATIONS

### Not Applicable

### (c) STATEMENT REGARDING FEDERALLY SPONSORED RESEARCH OR DEVELOPMENT

### Not Applicable

### (d) THE NAMES OF THE PARTIES TO A JOINT RESEARCH AGREEMENT

### Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

### Not Applicable

### (f) STATEMENT REGARDING PRIOR DISCLOSURES BY THE INVENTOR OR JOINT INVENTOR

### Not Applicable

### (g) BACKGROUND OF THE INVENTION

### (1) Field of the Invention

The disclosure relates to gardening tools and more particularly pertains to a new garden tool for digging and weeding. M any garden tools have a tool head with a straight cutting edge or a plurality of teeth that have the same length and tips that are all aligned on a straight line. Consequently, all of the teeth or all portions of the cutting edge engage the ground at the same time when digging, such that forces are evenly distributed across the entire tool head. The new garden tool includes teeth with a middle tooth that projects out further than the other teeth to concentrate the forces and facilitate digging with less effort.

### (2) Description of Related Art Including Information Disclosed Under 37 CFR 1.97 and 1.98

The prior art relates to rakes and similar garden tools. The prior art, as best understood, does not disclose a garden tool that includes a handle, a connector, and a tool head. The tool head includes a panel, a rear edge, a pair of side edges, and a toothed edge. The toothed edge includes a plurality of teeth projecting from the panel, wherein the tips of the teeth are positioned such that the tip of a middle tooth of the teeth is furthest from the panel.

### (h) BRIEF SUMMARY OF THE INVENTION

An embodiment of the disclosure meets the needs presented above in a garden tool generally comprising a handle, a connector, and a tool head. The handle includes a first handle end and a second handle end. The connector is coupled to the second handle end. The tool head is coupled to the connector. The tool head is positioned essentially perpendicular to the handle. The tool head includes a panel, a rear edge, a pair of side edges, and a toothed edge. The rear edge is adjacent the connector. The side edges extend from and transverse to the rear edge. The toothed edge extends between the side edges. The toothed edge includes a plurality of teeth projecting from the panel. Each of the teeth includes a tip. The tips of the teeth are positioned such that the tip of a middle tooth of the teeth is furthest from the panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a garden tool according to an embodiment of the disclosure.

FIG. 2 is a side view of an embodiment of the disclosure.

FIG. 3 is a front view of an embodiment of the disclosure.

FIG. 4 is a front view of an embodiment of the disclosure in use.

FIG. 5 is a side view of an embodiment of the disclosure in use.

FIG. 6 is a side view of an embodiment of the disclosure in use.

### (j) DETAILED DESCRIPTION OF THE INVENTION

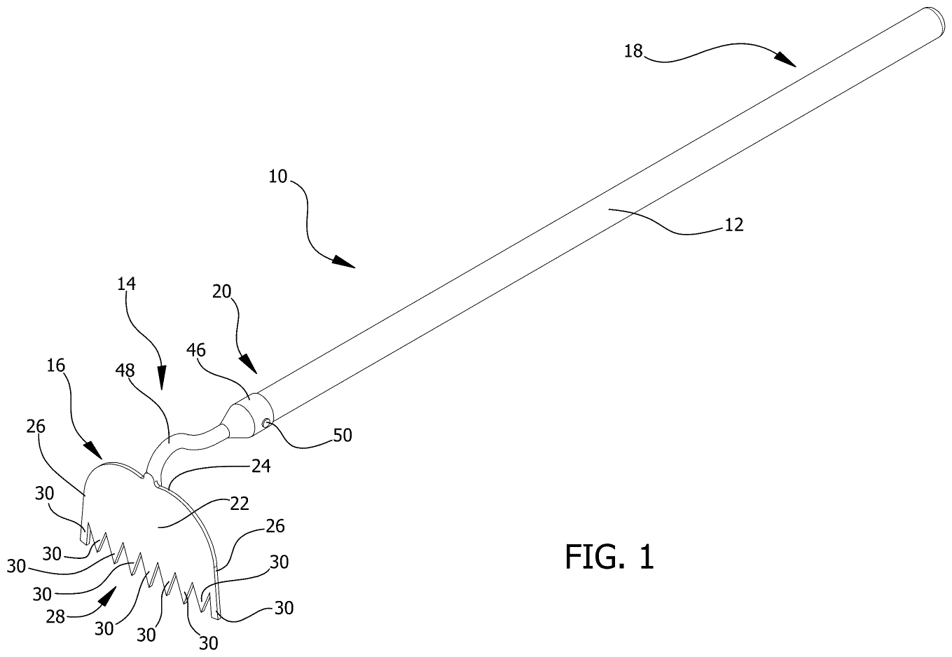

With reference now to the drawings, and in particular to FIGS. 1 through 6 thereof, a new garden tool embodying the principles and concepts of an embodiment of the disclosure and generally designated by the reference numeral 10 will be described.

As best illustrated in FIGS. 1 through 6, the garden tool 10 generally comprises a handle 12, a connector 14, and a tool head 16. The handle 12 includes a first handle end 18 and a second handle end 20. The connector 14 is coupled to the second handle end 20. The tool head 16 is coupled to the connector 14. The tool head 16 is positioned essentially perpendicular to the handle 12. The tool head 16 includes a panel 22, a rear edge 24, a pair of side edges 26, and a toothed edge 28.

The rear edge 24 is adjacent the connector 14. The side edges 26 extend from and transverse to the rear edge 24. The toothed edge 28 extends between the side edges 26. The toothed edge 28 includes a plurality of teeth 30 projecting from the panel 22. Each of the teeth 30 includes a tip 32. The tips 32 of the teeth 30 are positioned such that the tip 32 of a middle tooth 34 of the teeth 30 is furthest from the panel 22.

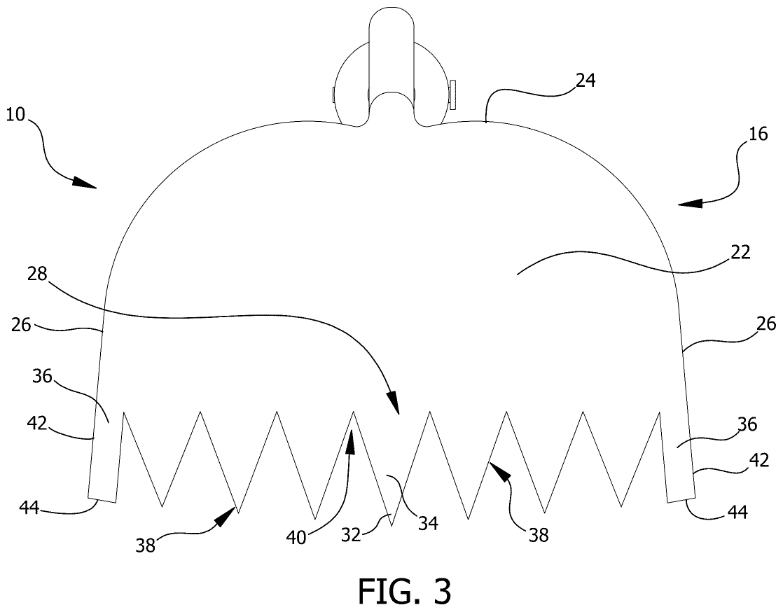

In the exemplary embodiment in FIG. 3, the teeth 30 include a pair of outermost teeth 36 and two sets of intermediate teeth 38. Each of the sets of intermediate teeth 38 is positioned between the middle tooth 34 and a respective one of the outermost teeth 36. The tips 32 of each of the sets of the intermediate teeth 38 are progressively closer to the panel 22 in a direction from the middle tooth 34 to a respective one of the outermost teeth 36.

In the exemplary embodiment in FIG. 3, the tips 32 of each of the sets of the intermediate teeth 38 are positioned to define a pair of lines (not shown) extending from the tip 32 of the middle tooth 34. The lines are oriented to define an angle in a range of 165 degrees to 175 degrees such that the teeth 30 define an angle of inclination in a range of 2.50 degrees to 7.50 degrees. In the exemplary embodiment, the lines are oriented to define an angle of 170 degrees such that the teeth 30 define an angle of inclination of 5.00 degrees.

In one possible embodiment, the angle of inclination could be greater than 7.50 degrees. In another possible embodiment, the tips 32 of each of the sets of the intermediate teeth 38 are not aligned on a line but still are progressively closer to the panel 22 proceeding from the middle tooth 34. In yet another possible embodiment, there could be two or three middle teeth 34, the tips 32 of which are aligned in a straight line. In the exemplary embodiment in FIG. 3, the middle tooth 34 is the longest of the teeth 30, and each opposing pair of the intermediate teeth 38 is the same length, such that bottoms of valleys 40 between the teeth 30 are aligned along a straight line.

Each of the outermost teeth 36 includes an outer edge 42. The outer edge 42 of each of the outermost teeth 36 is joined to and aligned with a respective one of the side edges 26.

Each of the outermost teeth 36 is rectangular and each of the middle tooth 34 and intermediate teeth 38 is triangular. The tip 32 of each of the outermost teeth 36 is a straight cutting edge 44 positioned at an angle in alignment with the tips 32 of each of the teeth 30 between the outermost teeth 36. The outer edge 42 of each of the outermost teeth 36 is positioned perpendicular to the cutting edge 44 of the respective one of the outermost teeth 36.

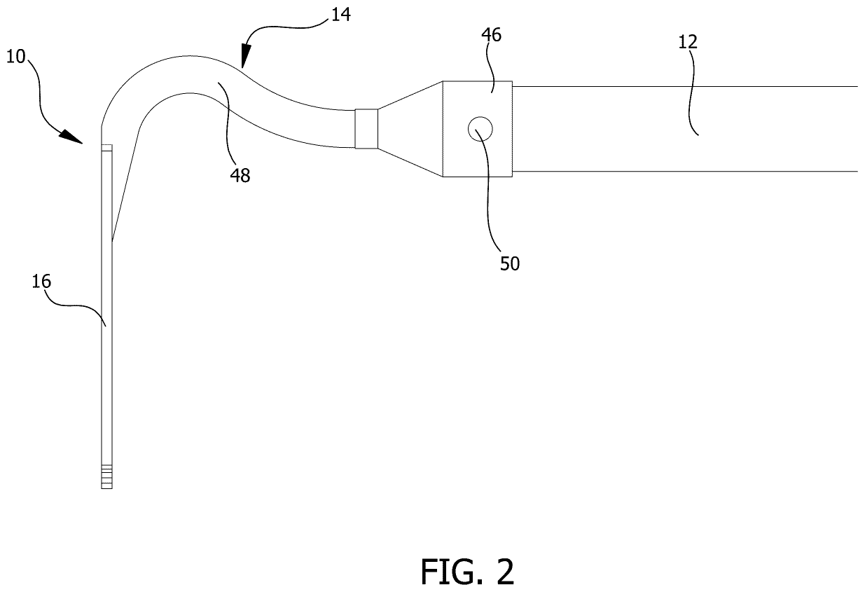

In the exemplary embodiment in FIGS. 2 and 3, the tool head 16 is flat and planar. However, in another possible embodiment, the tool head 16 could be curved like a scoop. The tool head 16 is substantially square, rectangular, or trapezoidal. In the exemplary embodiment in FIG. 3, the rear edge 24 is curved at the transition to the side edges 26.

The side edges 26 are oriented at an angle such that the side edges 26 taper inwardly from the toothed edge 28 to the rear edge 24, such as at an angle of inclination in a range of 2.50 degrees to 7.50 degrees, or possibly 5.00 degrees. In the exemplary embodiment in FIG. 3, the tool head 16 could be four to eight inches in width and four to eight inches in height.

The connector 14 includes a cap 46 and a neck piece 48 joined to and extending from the cap 46. The cap 46 is positioned on and around the second handle end 20. The cap 46 could be joined by a rivet 50 or bolt as shown. The neck piece 48 is joined to the tool head 16. The neck piece 48 is substantially S-shaped. However, in another possible embodiment, the neck piece 48 could be straight. The tool head 16 could be made of metal, such as aluminum or steel, and the handle 12 could be made of wood or metal.

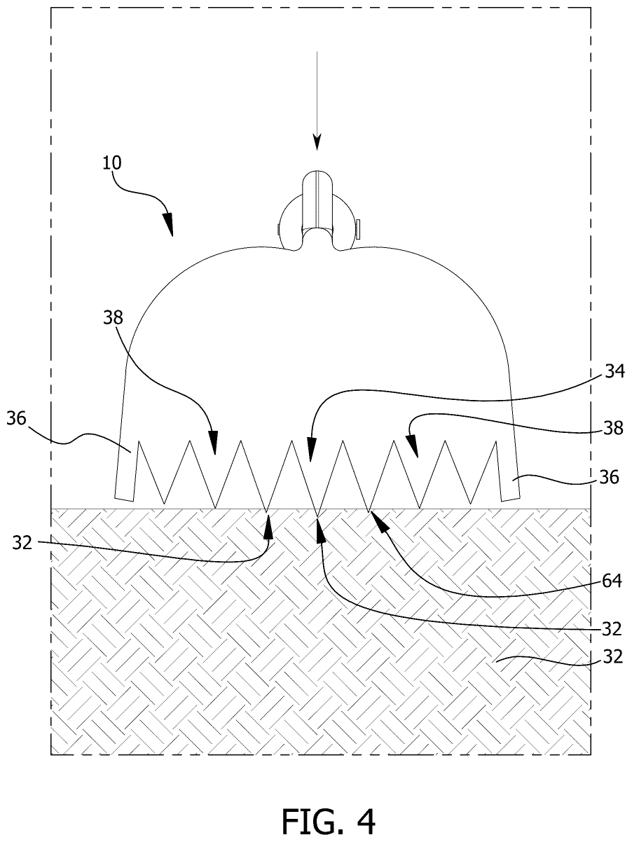

FIG. 4 shows the use of the garden tool 10 for digging into ground 64. The tool head 16 can be driven into the ground 64 perpendicular or essentially perpendicular to the ground 64. Since the middle tooth 34 projects out furthest, the impact forces are concentrated in the middle, thereby producing a stronger penetrating force to facilitate digging. Since the intermediate teeth 38 project less and less, the intermediate teeth 38 impact successively, thereby causing concentration of impact forces at each of the teeth 30 as the teeth 30 impinge into the ground 64.

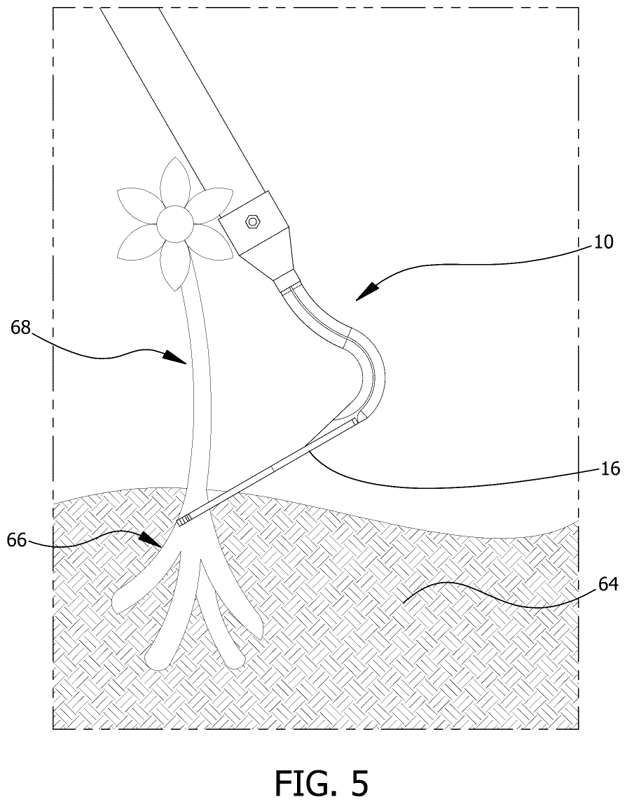

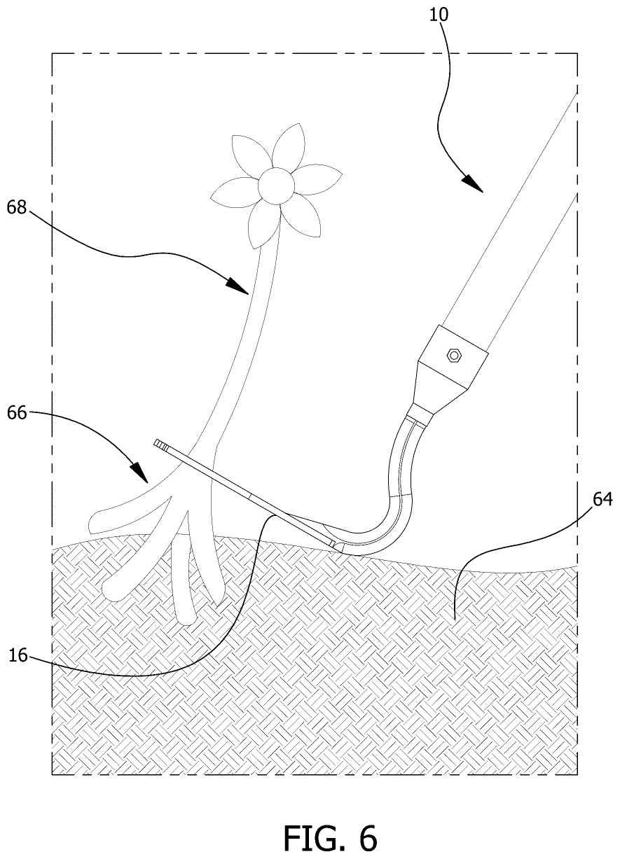

FIGS. 5 and 6 show another use of the garden tool 10. Two of the teeth 30 can be placed on either side of the roots 66 of a weed 68, such that the roots 66 are wedged into the valley 40 between the teeth 30, and the tool head 16 can then be pivoted upwardly to extract the weed 68. As the garden tool 10 is being used normally for digging, the teeth 30 will naturally engage and dig out roots and weeds by pulling, as opposed to straight-edged tools that would not do so.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A garden tool comprising:
a handle, the handle including a first handle end and a second handle end;
a connector, the connector being coupled to the second handle end; and
a tool head, the tool head being coupled to the connector, the tool head being positioned essentially perpendicular to the handle, the tool head including:
a panel;
a rear edge, the rear edge being adjacent the connector;
a pair of side edges, the side edges extending from and transverse to the rear edge; and
a toothed edge, the toothed edge extending between the side edges, the toothed edge including a plurality of teeth projecting from the panel, each of the teeth including a tip, the tips of the teeth being positioned such that the tip of a middle tooth of the teeth is furthest from the panel;
wherein the teeth include a pair of outermost teeth and two sets of intermediate teeth, the tip of each tooth of the sets of intermediate teeth being an intersection of straight edges defining a point;
wherein each of the sets of intermediate teeth is positioned between the middle tooth and a respective one of the outermost teeth; and
wherein the tips of each of the sets of the intermediate teeth are progressively closer to the panel in a direction from the middle tooth to a respective one of the outermost teeth.

2. (canceled)

3. The garden tool of claim 1, wherein:
the tips of each of the sets of the intermediate teeth are positioned to define a pair of lines extending from the tip of the middle tooth; and
the lines are oriented to define an angle in a range of 165 degrees to 175 degrees such that the teeth define an angle of inclination in a range of 2.50 degrees to 7.50 degrees.

4. The garden tool of claim 3, wherein the lines are oriented to define an angle of 170 degrees such that the teeth define an angle of inclination of 5.00 degrees.

5. The garden tool of claim 4, wherein:
each of the outermost teeth includes an outer edge; and
the outer edge of each of the outermost teeth is joined to and aligned with a respective one of the side edges.

6. The garden tool of claim 5, wherein each of the outermost teeth is rectangular and each of the middle tooth and intermediate teeth is triangular.

7. The garden tool of claim 6, wherein the tip of each of the outermost teeth is a straight cutting edge positioned at an angle in alignment with the tips of each of the teeth between the outermost teeth.

8. The garden tool of claim 7, wherein the outer edge of each of the outermost teeth is positioned perpendicular to the cutting edge of the respective one of the outermost teeth.

9. The garden tool of claim 8, wherein:
the connector includes a cap and a neck piece being joined to and extending from the cap;
the cap is positioned on and around the second handle end; and
the neck piece is joined to the tool head.

10. The garden tool of claim 9, wherein the neck piece is substantially S-shaped.

11. The garden tool of claim 1, wherein:
each of the outermost teeth includes an outer edge; and
the outer edge of each of the outermost teeth is joined to and aligned with a respective one of the side edges.

12. The garden tool of claim 11, wherein each of the outermost teeth is rectangular and each of the middle tooth and intermediate teeth is triangular.

13. The garden tool of claim 12, wherein the tip of each of the outermost teeth is a straight cutting edge positioned at an angle in alignment with the tips of each of the teeth between the outermost teeth.

14. The garden tool of claim 13, wherein the outer edge of each of the outermost teeth is positioned perpendicular to the cutting edge of the respective one of the outermost teeth.

15. The garden tool of claim 1, wherein:
the connector includes a cap and a neck piece being joined to and extending from the cap;
the cap is positioned on and around the second handle end; and
the neck piece is joined to the tool head.

16. The garden tool of claim 15, wherein the neck piece is substantially S-shaped.
